(19) United States
(12) Patent Application Publication
(10) Pub. No.: US 2020/0223048 A1
(43) Pub. Date: Jul. 16, 2020

(54) HAMMER DRILL

(71) Applicant: BLACK & DECKER INC., New Britain, CT (US)

(72) Inventor: Bruno RUETHERS, Bad Camberg (DE)

(21) Appl. No.: 16/712,353

(22) Filed: Dec. 12, 2019

(30) Foreign Application Priority Data
Jan. 16, 2019 (GB) 1900604.8

(51) Int. Cl. B25D 17/06; B25D 17/24; B25D 11/00

(52) U.S. Cl. CPC B25D 17/06; B25D 16/006; B25D 11/005; B25D 17/24

(57) ABSTRACT

A hammer drill is provided with a hammer mechanism that includes a cylinder having a central axis, a ram having a radial recess slidably mounted within the cylinder, a piston slidably mounted within the cylinder, and a ram catcher. The ram catcher includes a first ring and a second ring surrounding the central axis and forming a groove therebetween, the second ring being located between the first ring and the end of the cylinder. An O-ring that is resiliently-deformable is mounted within the groove and includes an inner side projecting inwardly towards the central axis. When the ram is in a working position, the O-ring is located forward of the ram. When the ram is in a forward position, the O-ring is located in-line with the radial recess of the ram.

### CROSS-REFERENCE TO RELATED APPLICATIONS

This application claims priority, under 35 U.S.C. § 119, to UK Patent Application No. 19 006 04.8 filed Apr. 3, 2019.

### FIELD

The present invention relates to a hammer drill, and in particular to a hammer drill having a ram, which is capable of repetitively imparting impacts onto a cutting tool, and a ram catcher for such a ram.

### BACKGROUND

A typical hammer drill comprises a body in which is mounted an electric motor and a hammer mechanism. A tool holder is mounted on the front of the body which holds a cutting tool, such as a drill bit or a chisel. The hammer mechanism typically comprises a ram, slidably mounted in a cylinder, reciprocatingly driven by a piston via an air spring, the piston being reciprocatingly driven by the motor via a set of gears and a crank mechanism or wobble bearing. The cylinder can be a separate component to the piston, the piston being mounted within the cylinder and capable of being reciprocatingly driven within the cylinder. Alternatively, the cylinder can be integrally formed with the piston, the piston being a hollow piston. The ram in turn repeatedly strikes the end of the cutting tool via a beat piece. When the only action on the tool bit is the repetitive striking of its end by the beat piece, the hammer drill is operating in a hammer only mode.

Certain types of hammer drill also comprise a rotary drive mechanism which enables the tool holder to rotatingly drive the cutting tool held within the tool holder. In such constructions, it can comprise a rotatable spindle. When the cylinder is separate from the piston, the cylinder can be integral with the rotatable spindle. The rotary drive can be in addition to the repetitive striking of the end of the cutting tool by the beat piece (in which case, the hammer drill is operating in a hammer and drill mode) or as an alternative to the repetitive striking of the end of the cutting tool by the beat piece by switching off the hammer mechanism (in which case, the hammer drill is operating in a drill only mode).

EP1157788 discloses an example of a hammer drill.

Typically, the beat piece of a hammer is mounted in a beat piece support structure which can be mounted either within the cylinder or directly in the housing of the hammer in front of the cylinder, or a combination of these.

During the operation of a hammer either in hammer only mode or in hammer and drill mode, when the cutting tool held by the tool holder is pressed against a work piece to cut the work piece, the reciprocating piston, driven by the motor, reciprocatingly drives the ram in order to repetitively strike the beat piece which in turn strikes the end of a cutting tool to cause the cutting tool to strike the work piece. When the cutting tool is removed from the work piece whilst the hammer mechanism is still activated, the piston continues to be reciprocatingly driven by the motor. However, it desirable to stop the ram from continuing to repetitively strike the beat piece as it will result in damaging the support structure for the beat piece and/or tool holder as the energy of the impacts are no longer being absorbed by the work piece.

One way of achieving this is to provide a ram catcher. US20090277659 provides an example of such a ram catcher.

A prior art design of hammer mechanism will new de described with reference to FIGS. 1 to 5.

Referring to FIG. 1, a hammer drill comprises a body 2 having a rear handle 4 movably mounted to the rear of the body 2. The rear handle 4 comprises a centre grip section 90 and two end connection sections 92; 94, one end connection section being attached to one end of the centre grip section, the other end connection section being connected to the other end of the centre grip section. The handle 4 is connected to the rear of the body 2 by the two end connection sections 92, 94. The rear handle is constructed from a plastic clam shell 100 and a rear end cap 102 which is attached to the clam shell 100 using screws (not shown). The rear of the body is formed by three plastic clam shells 6, 70, 72 which attach to each other and to the remainder of the body 2 using screws (not shown).

An SDS tool holder 8 is mounted onto the front 10 of the body 2. The tool holder can hold a cutting tool 12, such as a drill bit. A motor (shown generally by dashed lines 48) is mounted within the body 2 which is powered by a mains electricity supply via a cable 14. A trigger switch 16 is mounted on the rear handle 4. Depression of the trigger switch 16 activates the motor in the normal manner. The motor drives a hammer mechanism (shown generally by dashed lines 46 in FIG. 1), which comprises a piston 204 reciprocatingly driven by the motor via a crank shaft 206 within a spindle 150, which in turn reciprocatingly drives a ram 152 via an air spring 170 which in turn strikes, via a beat piece 156, the end of the cutting tool 12. The motor can rotationally drive the spindle 150 via a bevel gear 200 and torque clutch 202. A mode change mechanism (not shown) can switch the hammer drill between three modes of operation, namely hammer only mode, drill only mode or hammer and drill mode. A rotatable knob 18 is mounted on the top of the body 2. Rotation of the knob 18 changes the mode of operation of the hammer drill in well known manner.

Referring to the FIG. 2, the spindle 150 has a longitudinal axis 154. In side of the spindle 150 is located the ram 152, forward of the piston 204, a beat piece 156, forward of the ram 152, a ram catcher located between the ram 152 and the beat piece 156 and a beat piece support structure.

The forward end 162 of the spindle 150 forms part of the tool holder 8. During normal use, the cutting tool 12 (shown in dashed lines in FIG. 2) is held within the forward end 162 of the spindle 50 by the tool holder. The cutting tool 12 is prevented from rotating relative to the spindle 50 whilst being capable of moving axially over a limited range of movement within the forward end 162 of the spindle 150 in well known manner.

The piston 204 is mounted directly in the rear of the spindle 150 and comprises an O-ring 208 which locates in a groove formed around the main body of the piston and which provides an air tight seal between the piston and the inner wall of the spindle 150.

The ram 152 is mounted directly in the spindle 150 and comprises a main body 166 attached to an end cap 160, via a neck 168, of smaller diameter than the main body 166 of the ram 152, located at the forward end of the ram 152. The ram is circular in cross section in any plane which extends perpendicularly from the longitudinal axis 154 (which is co-axial with the longitudinal axis of the spindle 150 when the ram is located inside of the spindle) of the ram 152 along its length. The ram 152 comprises an O-ring 158 which locates in a groove formed around the main body 166 of the ram and which provides an air tight seal between the ram 152 and the inner wall of the spindle 150. During normal operation of the hammer, the ram 152 is reciprocatingly driven by the piston 204 via an air spring 170 formed between the piston 204 and ram 152 in well-known manner along the longitudinal axis 154. The air spring 170 between the ram 152 and the piston 204 is maintained by the air in the air spring 170 being prevented from escaping from (or air external of the air spring entering into) the space between the piston 204 and ram 152 due to the two O-rings 208, 158.

The ram catcher comprises a rubber ring 214 which locates against the inner wall of the spindle 150 and is axially held in position inside of the spindle by being sandwiched between a ring retainer, comprising a circlip 216 and metal washer 218, and a metal tubular insert 210 of the beat piece support structure, both being located inside of the spindle 150. The rubber ring 214 provides a lip which projects radially inwardly into spindle 150 towards the longitudinal axis 154. The diameter of the aperture formed by the rubber ring 214 is less than that of the end cap 160 of the ram 152 but similar to that of the neck 168 of the ram 152. A series of holes 220 are formed around the circumference of the spindle rearward of the circlip 216 which each extend through the wall of the spindle 150.

During the normal operation of the hammer drill, when the cutting tool is engaged with a work piece, the ram 152 is reciprocatingly driven over a range of axial positions (one of which is shown in FIG. 2) inside of the spindle located to the rear of the ram catcher, the ram 152 being prevented from engaging the ram catcher due to the position of the beat piece 156. The ring 214 has no contact with any part of the ram 152 during the normal operation of the tool. When the ram 152 is able to move forward, due to the position of the beat piece, the end cap 160 engages with the rubber ring 214 and passes through the aperture due to the ring deforming, allowing the lip to flex to enable the cap 160 to pass through it. Once the cap 160 has passed through the ring 214, the lip returns to its original shape, locating in the neck 168 of the ram to hold the ram 152 stationary (as shown in FIGS. 3 and 4).

The beat piece 156 is supported by a beat piece support structure formed in part by the spindle 150 and in part by a support structure inside the spindle 150 comprising a metal tubular insert 210 sandwiched between an O-ring 212 and the rubber ring 214 of the ram catcher. The beat piece 156 is circular in cross section in any plane which extends perpendicularly from the longitudinal axis 154 (which is co-axial with the longitudinal axis of the spindle 150 when the beat piece is located inside of the spindle) of the beat piece 156 along its length, the centre of the circular cross section being located on the longitudinal axis.

The beat piece 156 comprises a middle section 172, a front section 174 and a rear section 176.

The middle section 172 has a uniform-diametered circular cross section along its length, the centre of the circular cross section being located on the longitudinal axis 154.

The rear section 176 has a uniform-diametered circular cross section along its length, the centre of the circular cross section being located on the longitudinal axis 154. The rear end 240 of the rear section 176 is flat and is impacted by the cap 160 of the ram 152 during normal operation. The rear section 176 is joined to the middle section 172 via a first angled region 242. The first angled region 242 engages with a correspondingly shaped first angled shoulder 244 formed on the metal insert 210 located inside the spindle when the beat piece is in its most rearward position, limiting the amount of rearward movement of the beat piece 156. The wall of the angled shoulder 244 is circular in cross section in any plane which extends perpendicularly from the longitudinal axis 154 of the spindle 150, the centre of the circular cross section being located on the longitudinal axis. When the first angled region 242 is in engagement with the first angled shoulder 244, there is a uniform amount of contact between the two surfaces around the longitudinal axis 154.

The front section 174 is frusto-conical in shape centred around the longitudinal axis 154 of the beat piece 156. The front end 246 of the front section 174 is flat and impacts the cutting tool 12 during normal operation. The front section 174 is joined to the middle section 172 via a second angled region 248 which is frusto-conical in shape centred around the longitudinal axis 154 of the beat piece 156. The second angled region 248 engages with a correspondingly shaped second angled shoulder 250 formed on the inner wall of the spindle 150 when the beat piece is in its most forward position, limiting the amount of forward movement of the beat piece 156. The wall of the second angled shoulder 250 is circular in cross section in any plane which extends perpendicularly from the longitudinal axis 154 of the spindle 150, the centre of the circular cross section being located on the longitudinal axis 154. When the second angled region 248 is in engagement with the second angled shoulder 250, there is a uniform amount of contact between the two surfaces around the longitudinal axis 154.

When the hammer drill is operating in the normal manner with the cutting tool 12 cutting a work piece, the ram strikes the beat piece 156 which in turn strikes the end of cutting tool 12 in the tool holder 8. The ram 152 is reciprocatingly driven over a limited range of axial movement within the spindle, the maximum distance from the piston being limited by the position of the beat piece 156 which it impacts, the position of which in turn is controlled by the end of the cutting tool 12. Whilst traveling within this range of axial movement, the O-ring 158 of the ram 152 does not pass the holes 220. As such, the air spring 170 between the piston 204 and ram 152 is maintained. The rear section 176 projects rearwardly through the aperture of the ring 214 of the ram catcher, to enable the cap 160 of the ram 152 to strike it as shown in FIG. 2.

When the cutting tool 12 is removed from the work piece, the beat piece 156 is able to move forward as the cutting tool 12 can extend out of the tool holder 8 to its maximum position. If the motor is still running, the piston 204 is able to drive the ram 152 via the air spring 170 further along the spindle 150, as the beat piece 156 can move forward, passing the air holes 220. Once the O-ring 158 of the ram 152 has passed the air holes 220, the air is able to freely pass into and out of the spindle 150 in the space between the piston 204 and ram 152, causing the air spring 170 to be broken and thus disconnecting the drive between the piston 204 and ram 152. As the air spring 170 is broken, the ram 152 is able freely continue to travel along the length of the spindle 150. The ram 152 engages with the ram catcher, the cap 160 passing through the ring 214 allowing the neck 168 to engage with the ring, to secure the ram in the ram catcher, as seen in FIGS. 3 and 4. The reciprocating movement of the piston 204 has no effect on the ram 152 as the air spring 170 is broken due to the holes 220 which allow air in and out of the spindle 170 in the space between the piston 204 and ram 152. The beat piece 156 is pushed forward in the spindle 150 by the ram 152 in the ram catcher. In order to release the ram 152 from the ram catcher, the cutting tool 12 is pressed against a work piece causing it to be pushed into the tool holder 8, which in turn pushes the beat piece 156 rearwardly into engagement with the cap 160 of the ram 152, pushing it out of the ram catcher and past the holes 220. In such a position, the air spring 170 is reformed and the piston 204 is able to reciprocatingly drive the ram 152 again.

A problem associated with known designs of ram catchers is that they are mounted inside of the cylinder or spindle in which the ram is slidably mounted. As such, assembly of such ram catchers is made difficult as the ram catch as a whole or the component parts of the ram catcher have to be inserted into the cylinder or spindle through one of the open ends of the cylinder or spindle.

### SUMMARY

To overcome these problems, there is provided a hammer drill with a hammer mechanism that includes a cylinder having a central axis, a ram having a radial recess slidably mounted within the cylinder, a piston slidably mounted within the cylinder, and a ram catcher. The ram catcher includes a first ring and a second ring surrounding the central axis and forming a groove therebetween, the second ring being located between the first ring and the end of the cylinder. An O-ring that is resiliently-deformable is mounted within the groove and includes an inner side projecting inwardly towards the central axis. When the ram is in a working position, the O-ring is located forward of the ram. When the ram is in a forward position, the O-ring is located in-line with the radial recess of the ram.

### BRIEF DESCRIPTION OF THE DRAWINGS

Preferred embodiments of the present invention will now be described, by way of example only and not in any limitative sense, with reference to the accompanying drawings in which:

FIG. 1 shows a sketch of a side view of a prior art hammer drill;

FIG. 2 shows a cross sectional view of the hammer mechanism of the hammer drill of FIG. 1 with the ram in a position where it can freely slide within the spindle;

FIG. 3 shows a cross sectional view of the hammer mechanism of FIG. 2 with the ram in the ram catcher and the beat piece sliding in the spindle;

FIG. 4 shows a cross sectional view of the hammer mechanism of FIG. 2 with the ram in the ram catcher and the beat piece in its furthest forward position in the spindle;

FIG. 5 shows the beat piece of the hammer mechanism of FIG. 2;

FIG. 6 shows a cross sectional view of a hammer mechanism of a hammer drill according to an embodiment of the present invention;

FIG. 7 shows an exploded view of the cylinder, ram, beat piece and ram catcher of the hammer mechanism shown in FIG. 6;

FIG. 8 shows a cross sectional view of the cylinder, ram, beat piece and ram catcher of the hammer mechanism of FIG. 6 with the ram and beat piece in their working positions; and

FIG. 9 shows a cross sectional view of the cylinder, ram, beat piece and ram catcher of the hammer mechanism of FIG. 6 with the ram caught by the ram catcher.

### DETAILED DESCRIPTION

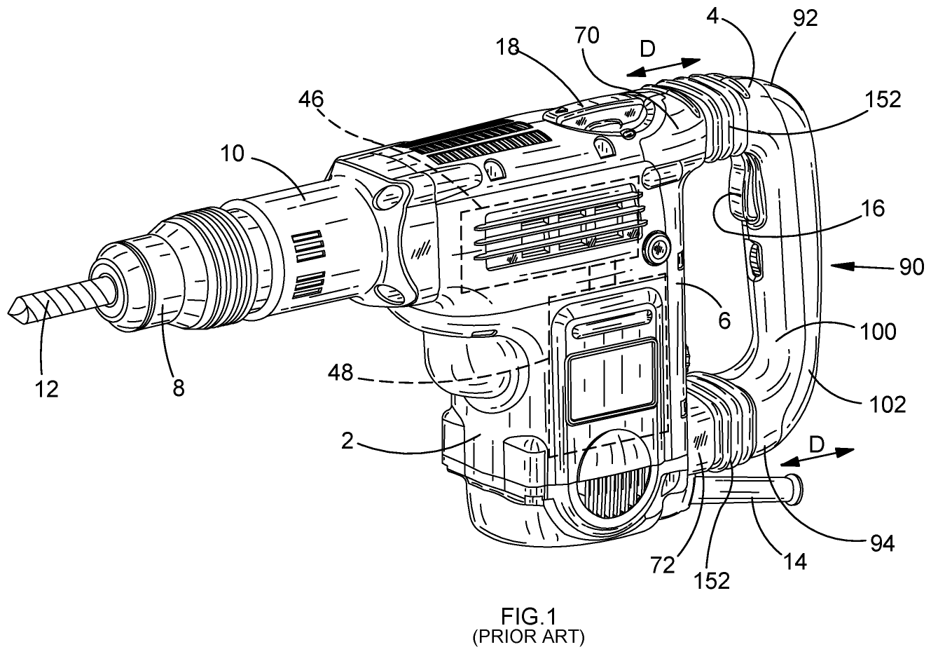

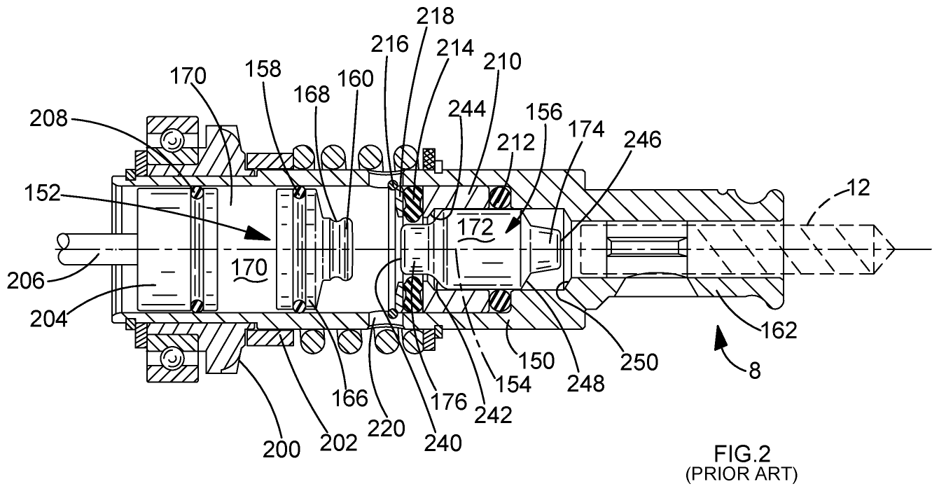

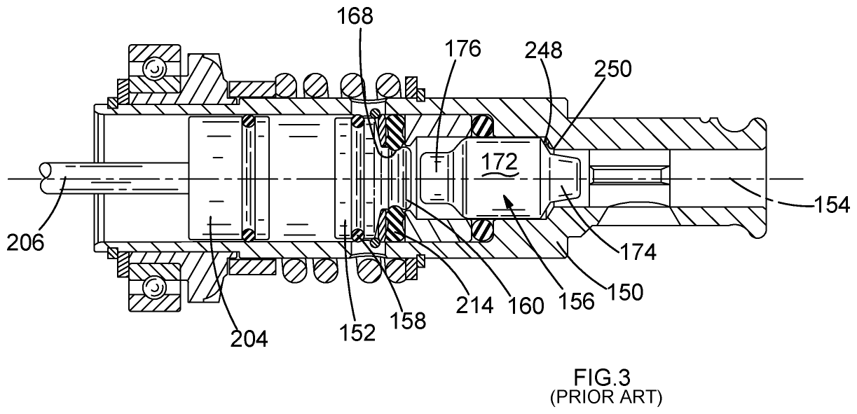

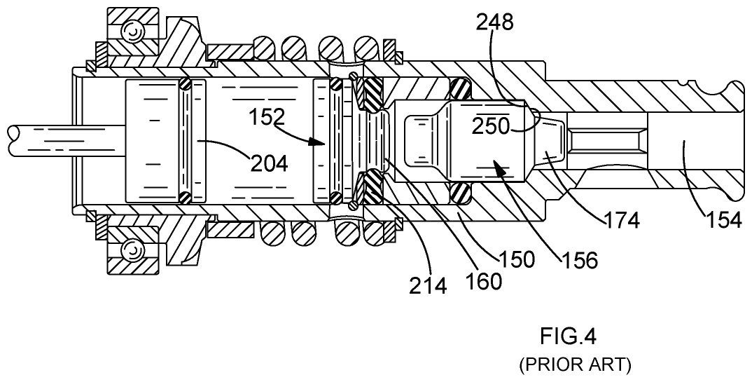

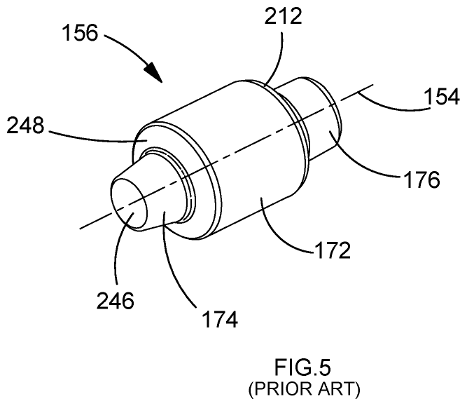

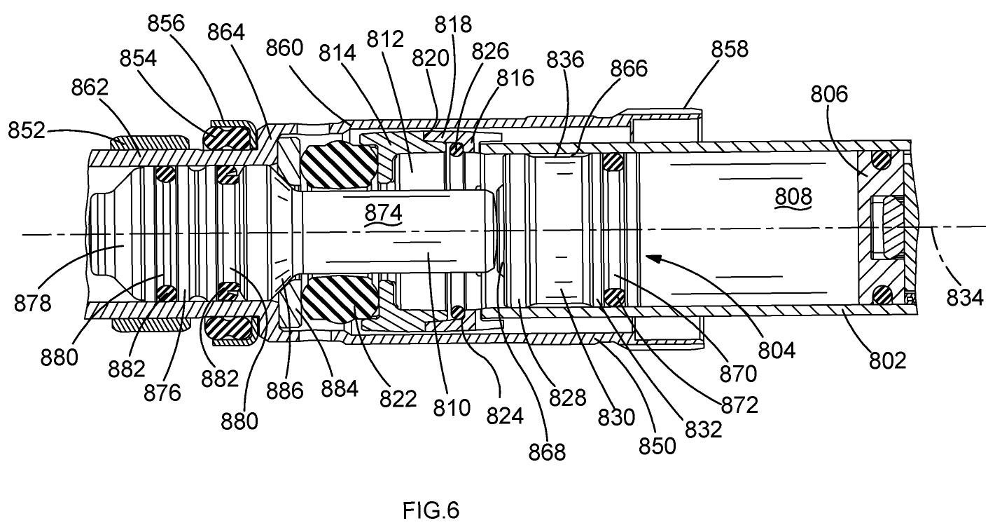

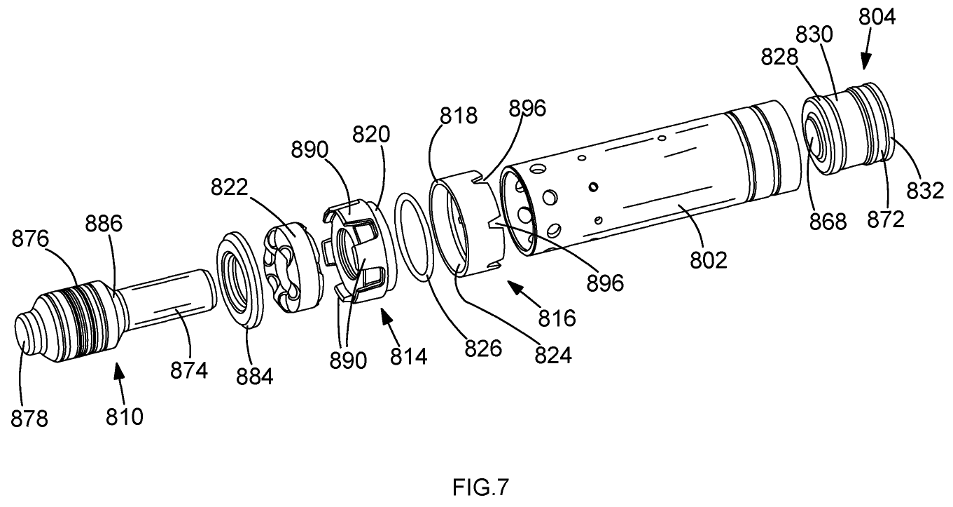

An embodiment of the present invention will now be described with reference to FIGS. 6 to 9. The external construction of the hammer drill which includes the embodiment of the present invention is the same as the prior art design described with reference to FIG. 1 and comprises an electric motor 48 and a hammer mechanism 46. The overall operation of the hammer drill which includes the embodiment of the present invention (excluding the ram and ram catcher, beat piece and beat piece dampener), is similar to that described with reference to FIGS. 1 to 5 and is well known in the art. As such, no further description shall be provided.

Referring to FIGS. 6 to 9, the hammer drill comprises a rotatable tubular spindle 850 which a capable of being rotationally driven by an electric motor 48 via a set of gears (not shown) which engage with a splined section 858 of the spindle 850. The spindle 850 comprises a rear section 860 having a larger cross section connected to a front section 862 having a smaller cross section via a shoulder 864. The spindle 850 is mounted within the body 2 of the hammer drill using bearings 852, one set of which surround the front section 862. A rubber dampener 854 and metal ring 856 engage with the shoulder 864 to bias the spindle 850 rearwardly (right in FIG. 6). Rotation of the spindle 350 can be activated or deactivated using a mode change mechanism (not shown) so that the hammer drill can perform drill only mode, hammer only mode or hammer and drill mode.

The hammer mechanism of the hammer drill comprises a cylinder 802 which is rigidly mounted within the body 2 so that it cannot be moved axially or rotationally. The front (left hand side in FIG. 6) of the cylinder 802 extends inside of a cavity 866 formed by the rear section 860 of the spindle 850.

Slidingly mounted within the cylinder 802 is a ram 804. The ram 804 is circular in cross section and comprises a front section 828 having a diameter approximately equal to that of the inner diameter of the cylinder 802, a middle section 830 of reduced diameter, and a rear section 832 also having a diameter approximately equal to that of the inner diameter of the cylinder 802. A nose 868 is formed on the front of the ram 804 which is capable of striking a beat piece 810. A groove 870 is formed in the rear section 832 in which is located an O-ring 872. The O-ring 872 acts as seal between the ram 804 and the cylinder 802 in well-known manner.

The ram 804 is reciprocatingly driven by a reciprocating piston 806, which is slidably mounted within the cylinder 802, via an air spring 808 when the hammer mechanism is activated in well-known manner. During the normal operation of the hammer mechanism, the ram 804 repetitively strikes a beat piece 810 which in turn transfers the impact to a cutting tool in well-known manner.

The beat piece 810 is circular in cross section and comprises a rear section 874 having narrow cross section, a middle section 876 having a larger cross section, a front section 878 which tapers inwardly as it projects forward. The rear of the rear section 874 is struck by the ram. The middle section 876 is slidingly mounted within the front section 862 of the spindle 850, the middle section 876 having an outer diameter which is approximately the same as the inner diameter of the front section 862 of the spindle 850. Two grooves 880 are formed around the middle section 876. An O-ring 882 is located in each of the grooves 880 which act as seals between the middle section 876 and the front section 862 of the spindle 850 in well-known manner. The front section 878 strikes the rear end of a cutting tool during the normal operation of the hammer mechanism.

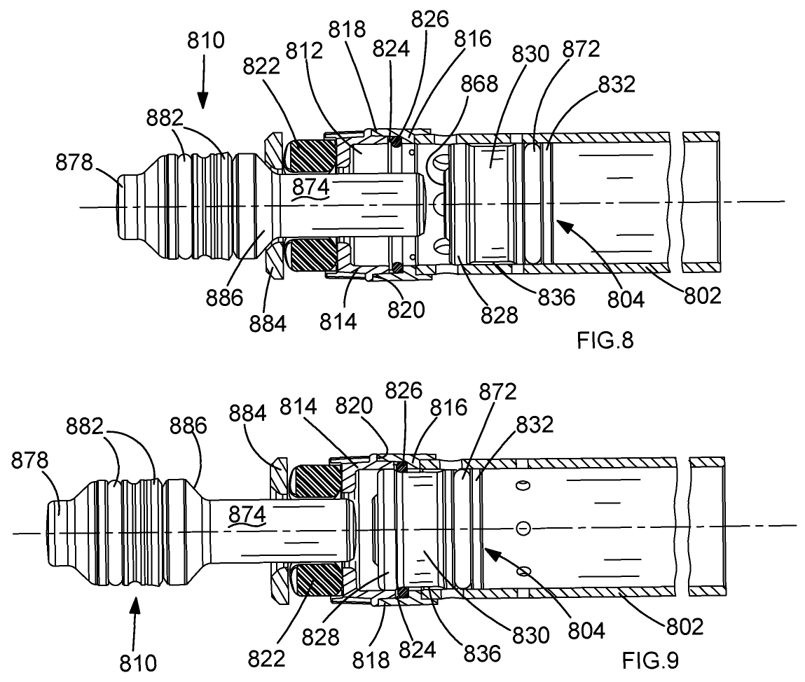

During the normal operation of the hammer mechanism (shown in FIG. 8), the piston 806 is reciprocatingly driven by the electric motor 48 within the spindle 850. The reciprocating piston 806 reciprocatingly drives the ram 804 via the air spring 808. The recicoprocating ram 804 repetitively strikes the rear 874 of the beat piece 810 which in turn transfers the impacts on the rear end of a cutting tool 12.

When the hammer drill disengages from a work piece whilst the hammer mechanism is still operating, the beat piece 810 moves to its most forward position (left) allowing the ram 804 to move to a forward space 812 where it is caught by a ram catcher (as shown in FIG. 9).

The ram catcher comprises a first plastic ring 814 which mates with a second plastic ring 816 by a rim 818 on the second plastic ring 816 locating within a recess 820 of the first plastic ring 14. The second ring 816 is mounted adjacent to and on the end of the cylinder 802. The first ring 814 is mounted adjacent to and on the second ring 816, with the second ring 816 being located between the first ring 814 and the end of the cylinder 802. The plastic rings 814, 816 are held in position by being sandwiched between a rebound dampener 822, which comprises a rubber ring, and the front end of the cylinder 802.

The rebound dampener 822 is designed to absorb impacts from the movement of the beat piece when it rebounds (travels to the right in FIG. 6) off the end of a cutting tool. When the beat piece 810 rebounds, it travels towards the ram 804 until a rear shoulder 886 of the middle section 876 of the beat piece 810 strikes a rebound washer 884 which transfers the impact to the rebound dampener 822. Rearward movement of the rebound dampener 822 is prevented by the first and second plastic rings 814, 816 which are in engagement with the end of the cylinder 802. As such, the rebound dampener 822, which is made from resilient material such as rubber, compresses, thereby absorbing the energy from the rearward movement of the beat piece 810, preventing further rearward movement of the beat piece 810. The first ring 814 comprises a series of tabs 890.

The tabs 890 center and guide the rebound dampener 822.

The rebound dampener 822 is sandwiched between the rebound washer 884 and the first plastic ring 814. The rebound washer 884 abuts against the shoulder 864 of the spindle 850. The rubber dampener 854 and metal ring 856 urges shoulder 864 rearwardly, which in turn urges the rebound washer 884 towards the rebound damper 822, which in turn urges the rebound dampener 822 towards the first plastic ring 814, which in turn urges the first plastic ring 814 towards the second plastic ring 816, which in turn is urged into engagement of the front end of the cylinder 802. In this manner, the rebound dampener 822 and the first and second rings 814, 816 are held in position.

As the end of cylinder 802 extends inside of the spindle 850, the first and second rings 814, 816 are located within the spindle 350, the first and second rings being mounted between the shoulder 864 and the end of the cylinder 802.

A radially inward facing ring groove 824 is formed by the adjoining parts of the two rings 814, 816. A resiliently deformable O-ring 826 is located within the groove 824. An inner side of the O-ring 826 projects inwardly towards a central axis 834 of the cylinder 802. The groove 824 is shallow enough in a radial direction to ensure that the inner side of the O-ring 826 is maintained in an inwardly projecting position. The depth of the groove 824 is a radial direction is less than the thickness of the O-ring 826 in a radial direction when the O-ring 826 is in its original shape. The groove 824 can be the same width but ideally is wider in a direction parallel to the axis 834 of the cylinder 802 than the width of the O-ring 826 in a direction parallel to the axis (834) of the cylinder 802 when it is in its original shape. The groove (824) is ideally the same width or wider a direction parallel to the axis 834 of the cylinder than the width of the O-ring 826 in a direction parallel to the axis 834 of the cylinder 802 when it is compressed by the ram 804 as thee ram passes the O-ring 826. The groove 824 is sufficiently wide enough in a direction parallel to the axis 834, to avoid squeezing the O-ring 826 as well as providing enough space to allow the O-ring 826 to be compressed by the ram 4 when it passes the O-ring 826.

During normal operation of the hammer (FIG. 8), the ram 804 is located to the rear (right) of the O-ring 826. However, when the ram 804 is caused to move towards the forward space 812 (FIG. 9), the front section 828 of the ram 804 engages with the O-ring 826 causing it to compress into the groove 824 as the front section 828 passes the O-ring 826. Once the front section 828 has passed the O-ring 826, the O-ring 826 reverts to its original shape, the inner side of the O-ring 826 which projects inwardly towards the central axis 834 of the cylinder 802 entering the space 836 adjacent the middle section 30 between the front section 828 and the rear section 832. As the ram 804 moves forward, an air cushion is formed in front of the ram 804. The increased air pressure of the air cushion slows the ram down. The second plastic ring 316 comprises a series of openings 896. The openings 896 allow the air in the cushion to be vented as the ram 804 is slowed down. The O-ring 826 is sufficiently resilient to hold the ram 804 if it rebounds, preventing the front section 828 passing back over the O-ring 826 as the ram 804 has lost a lot of momentum. The O-ring 826 then holds the ram 804 in the forward position.

The ram 804 is disengaged from the ram catcher by the beat piece being moved rearwardly towards and into engagement with the ram 804, the beat piece 810 then pushing the ram 804 rearwardly. As the ram 804 moves rearwardly (right in FIG. 6), the front section 828 engages with the O-ring 826 causing it to compress as the front section 828 passes the O-ring 826. Once the front section 828 has passed the O-ring 826, the O-ring 826 reverts to its original shape, the inner side of the O-ring 826 which projects inwardly towards the central axis 834 of the cylinder 802 being now located in front of the ram 804.

In the prior art design described with reference to FIGS. 1 to 5, the ram 152 comprises a main body 166 attached to an end cap 160, via a neck 168 for receiving the rubber ring 214 of the ram catcher, the end cap 160 and neck 168 being located at the forward end of the ram 152. The ram 304 in the present embodiment comprises a front section 828 having a first diameter, a middle section 830 of reduced diameter which receives the O-ring 826 of the ram catcher, and a rear section 832 having a diameter equal to that of the front section. As the ram 804 has a middle section 830 of reduced diameter which is capable of engaging the O-ring of the ram catcher, the end cap 160 and neck 168 can be replaced by a smaller nose 868 formed on the front of the ram. As such, the length of ram and hence the length of the hammer mechanism can be reduced.

Whilst the embodiment of the invention has been described with a flat piston mounted directly within a cylinder which reciprocatingly drives a ram mounted directly within the cylinder, it will be appreciated that the invention can also be utilized on a hammer mechanism comprising a hollow piston where the hollow piston is mounted directly in the cylinder and the ram is mounted within the hollow piston, the ram being mounted indirectly within the cylinder.

It will be appreciated by persons skilled in the art that the above embodiments have been described by way of example only and not in any limitative sense, and that various alterations and modifications are possible without departure from the scope of the invention as defined by the appended claims.

Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

1. A hammer drill comprising:
a body;
a tool holder mounted on the body configured to hold a cutting tool;
a motor mounted within the body; and
a hammer mechanism mounted inside of the body,
wherein the hammer mechanism comprises:
a cylinder being axially fixed relative to the body and having a central axis;
a ram having a radial recess slidably mounted within the cylinder;
a piston slidably mounted within the cylinder capable of being reciprocatingly driven within the body by the motor when the motor is activated to reciprocatingly drive the ram within the cylinder, the ram imparting impacts to the cutting tool held by the tool holder; and
a ram catcher comprising: a first ring and a second ring surrounding the central axis and forming a groove therebetween, the second ring being located between the first ring and the end of the cylinder; and an O-ring being resiliently-deformable mounted within the groove, the O-ring having an inner side projecting inwardly towards the central axis,
wherein, when the ram is in a working position, the O-ring is located forward of the ram and, when the ram is in a forward position, the O-ring is located in-line with the radial recess of the ram.

2. The hammer drill of claim 1, wherein the second ring is mounted on the end of the cylinder.

3. The hammer drill of claim 1, wherein the first ring is mounted on the second ring.

4. The hammer drill of claim 1, wherein one of the first ring or the second ring comprises a rim and the other of the first ring or the second ring comprises a recess, the rim locating within the recess when the first ring is mounted adjacent the second ring.

5. The hammer drill of claim 1, wherein the groove includes a depth in a radial direction configured to ensure that the inner side of the O-ring is maintained in an inwardly projecting position when the O-ring is not compressed.

6. The hammer drill of claim 5, wherein the depth of the groove in the radial direction is less than a width of the O-ring in the radial direction when the O-ring is not compressed.

7. The hammer drill of claim 1, wherein the groove has a width in a direction of the central axis equal to or greater than a width of the O-ring in the direction of the central axis when the O-ring is not compressed.

8. The hammer drill of claim 1, wherein the groove has a width in a direction of the central axis (834) equal to or greater than a width of the O-ring in the direction of the central axis when the O-ring is compressed by the ram.

9. The hammer drill of claim 1, wherein the first and second rings are mounted between the end of the cylinder and a component part of the body.

10. The hammer drill of claim 9, wherein the first and second rings are sandwiched between the end of the cylinder and a component part of the body.

11. The hammer drill of claim 1, further comprising a spindle rotationally driven by the motor, wherein the first and second rings are mounted between the end of the cylinder and spindle.

12. The hammer drill of claim 11, wherein the end of cylinder extends inside of the spindle, the first and second rings being located within the spindle.

13. The hammer drill of claim 11, wherein the spindle comprises a shoulder, the first and second rings being mounted between the shoulder and the end of the cylinder.

14. The hammer drill of claim 13, further comprising:
a beat piece mounted within the spindle forward of the shoulder; and
a beat piece dampener sandwiched between the shoulder and the first ring.

15. The hammer drill of claim 14, further comprising a beat piece washer sandwiched between the shoulder and the beat piece dampener.

16. The hammer drill of claim 14, wherein the first ring comprises tabs for guiding the beat piece dampener.

17. The hammer drill of claim 1, wherein the second ring comprises recesses through which air can pass.

18. The hammer drill of claim 1, wherein the ram comprises a first end section, a second middle section, and a third end section, the second middle section forming the radial recess.

19. The hammer drill of claim 1, wherein the piston is a hollow piston, the ram being mounted within the piston.

20. The hammer drill of claim 1, wherein the piston is slidably mounted within the cylinder, the piston being reciprocatingly driven by the motor within the cylinder.
